(19) United States
(12) Patent Application Publication
(10) Pub. No.: US 2010/0103273 A1
(43) Pub. Date: Apr. 29, 2010

(54) COMMUNICATION APPARATUS, CONTROL METHOD OF COMMUNICATION APPARATUS, PROGRAM, AND SYSTEM

(75) Inventor: Masashi Hamada, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/607,010

(22) Filed: Oct. 27, 2009

(30) Foreign Application Priority Data
Oct. 28, 2008 (JP) 2008-276986
Dec. 17, 2008 (JP) 2008-321629

(51) Int. Cl. H04N 5/225; H04N 5/00

(52) U.S. Cl. 348/207.1; 386/117; 386/E05.001

(57) ABSTRACT

A communication apparatus includes a transfer unit configured to transfer data to an external apparatus, and a determination unit configured to determine that a transfer of first data is completed by the transfer unit, wherein the transfer unit transfers second data, at a reduced communication speed, to cause the external apparatus to operate the first data, after the determination unit determines that the transfer of the first data has been completed.

### BACKGROUND OF THE INVENTION

1. Field of the Invention

The present invention relates to a communication apparatus that changes a communication speed, a control method of the communication apparatus, program, and system.

2. Description of the Related Art

There is a conventional display apparatus which transfers and stores video information stored in an imaging apparatus using a personal area network (PAN) such as a universal serial bus (USB), and executes reproduction control of the video information.

Since a wireless communication interface (wireless PAN) appeared, it is possible to wirelessly transfer content data stored in an imaging apparatus to a video storage apparatus. For instance, Japanese Patent Application Laid-Open No. 2002-142212 discusses a technology for wirelessly transferring content data stored in an imaging apparatus to a personal computer.

However, a user has to use an operation unit of an apparatus at a transfer destination to control display and reproduction of the transferred video file, and cannot use an operation unit of an apparatus with which the user is familiar. Therefore, there is a problem that the user must recognize an operation method of each operation unit of the apparatus at the transfer destination to perform intended reproduction (Fast Feed, Rewind, Still, Slow, etc.) of the video file.

If a user wishes to display and reproduce the transferred video file using the operation unit of the apparatus with which the user is familiar, it is necessary to make communication between apparatuses to transfer data of the video file.

However, if the apparatus with which the user is familiar and the apparatus at the transfer destination are far apart from each other, communication quality may deteriorate or disconnection may occur.

### SUMMARY OF THE INVENTION

The present invention is directed to solving a problem that may occur when apparatuses which perform communications are located far apart from each other.

According to an aspect of the present invention, a communication apparatus includes a transfer unit configured to transfer data to an external apparatus, and a determination unit configured to determine that a transfer of first data is completed by the transfer unit, wherein the transfer unit transfers second data, at a reduced communication speed, to cause the external apparatus to operate the first data, after the determination unit determines that the transfer of the first data has been completed.

According to another aspect of the present invention, a communication apparatus includes a transfer unit configured to transfer data to an external apparatus, and a determination unit configured to determine that data to be transferred is second data for causing the external apparatus to operate first data which is transmitted previously, wherein if the determination unit determines the data to be transferred as the second data, the transfer unit transfers the second data at a reduced communication speed.

According to yet another aspect of the present invention, a communication apparatus includes an acquisition unit configured to acquire data from an external apparatus, a storage unit configured to store the data acquired by the acquisition unit, and a deletion unit configured to delete the data stored in the storage unit, if communication with the external apparatus is disconnected.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a system configuration diagram.

FIG. 2 is a conceptual diagram illustrating connection states of a close proximity wireless communication apparatus.

FIG. 3 is a functional block diagram of a close proximity wireless communication apparatus.

FIG. 4 is a flowchart illustrating setting and releasing of a link between communication applications which utilizes the close proximity wireless communication.

FIG. 5 is a sequence chart illustrating setting and releasing of a link between communication applications that utilizes the close proximity wireless communication.

FIG. 6 is a flowchart illustrating setting and releasing of a link between communication applications that utilizes the close proximity wireless communication.

### DESCRIPTION OF THE EMBODIMENTS

Various exemplary embodiments, features, and aspects of the invention will be described in detail below with reference to the drawings.

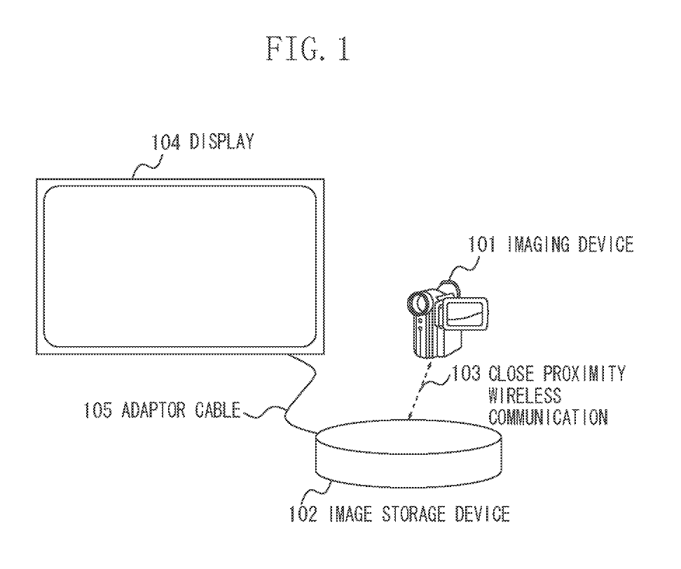

FIG. 1 is a system configuration diagram according to a first exemplary embodiment. The system includes an imaging device 101 as an example of a communication apparatus, an image storage device 102 as an example of an external apparatus, and a display 104. The imaging device 101 and the image storage device 102 are connected via a close proximity wireless communication 103.

The close proximity wireless communication 103 can be connected by switching to a communication speed corresponding to a wireless connection quality. The close proximity wireless communication 103 includes, for instance, non-contact type integrated circuit (IC) card wireless communication and a Near Field Communication (NFC) utilizing electromagnetic induction, and communication utilizing induction field.

The display 104 communicates with the imaging device 101 via the image storage device 102. The display 104 and the image storage device 102 are connected via an adapter cable 105.

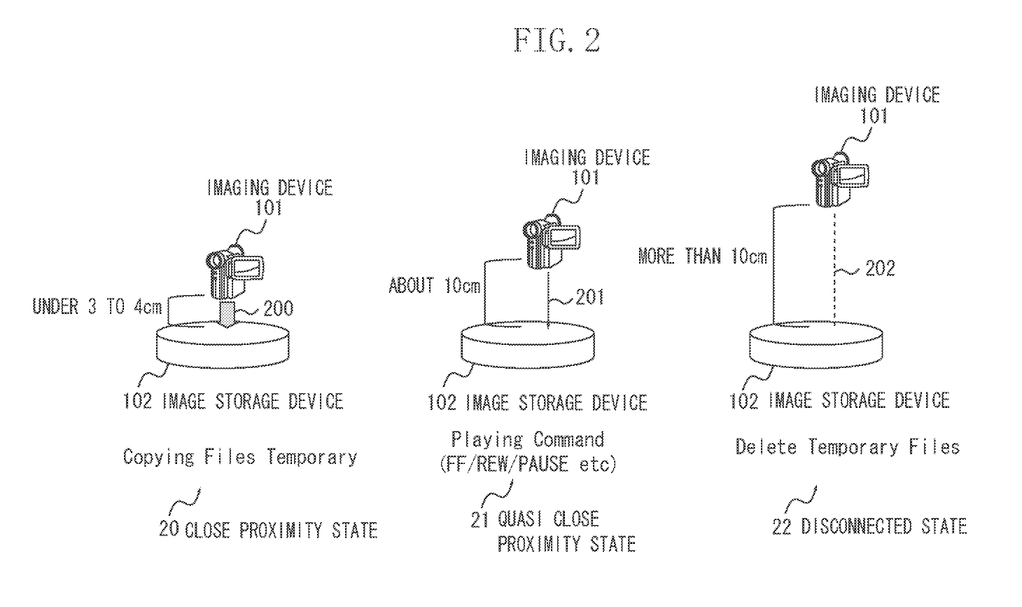

FIG. 2 is a conceptual diagram of a close proximity wireless communication connection for each state of the imaging device 101 and the image storage device 102 in the exemplary embodiment of the present invention.

A state 20 represents that the imaging device 101 and the image storage device 102 are connected in a close proximity state. In the close proximity state 20, the imaging device 101 and the image storage device 102 can communicate with each other at an arbitrary communication speed between high speed and low speed. In the state, the imaging device 101 can transfer content data (first data) such as a video file to the image storage device 102 at high speed. The communication speed can be changed by changing a coding method, a modulation method, a spreading code or the like used in the wireless communication.

A state 21 represents that the imaging device 101 and the image storage device 102 are farther apart than the close proximity state 20. In a quasi close proximity state 21, when the imaging device 101 and the image storage device 102 communicate with each other at high speed, errors in communication frames frequently occur.

A state 22 represents that the imaging device 101 and the image storage device 102 are even farther apart than the quasi close proximity state 21, and they are disconnected.

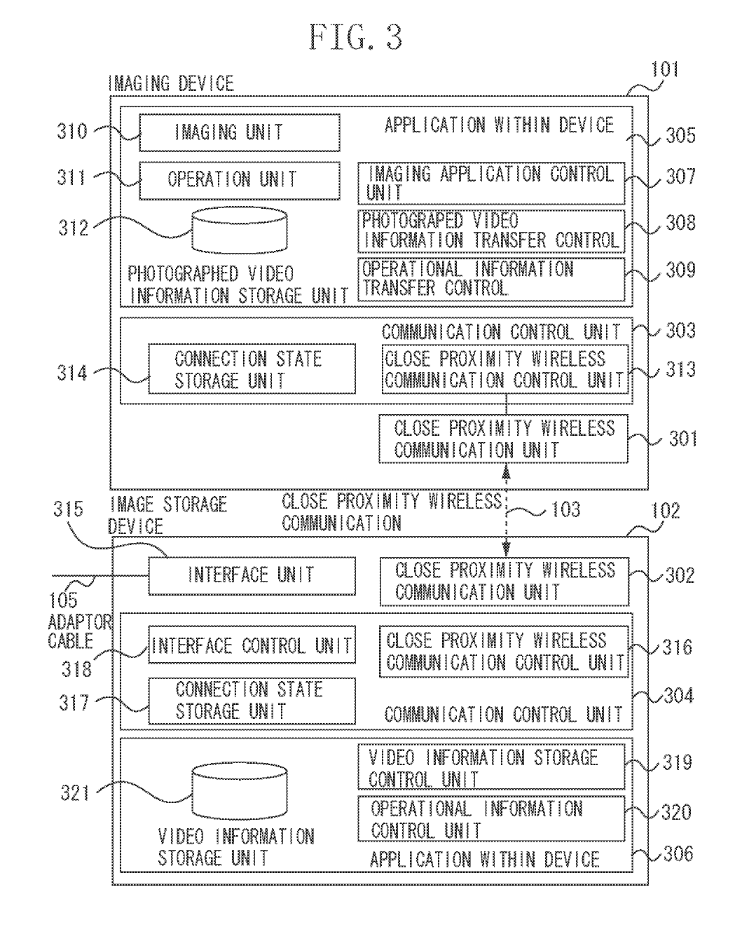

FIG. 3 is a functional block diagram of the imaging device 101 and the image storage device 102 in the exemplary embodiment the present invention.

A close proximity wireless communication unit 301 performs a close proximity wireless communication 103. A communication control unit 303 performs control of a communication interface of the imaging device 101. The communication control unit 303 includes a central processing unit (CPU) and a memory (not illustrated). A connection state storage unit 314 stores which of the connection states 20 to 22 the imaging device 101 is in.

An application within apparatus 305 provides imaging and storage functions of the imaging device 101. The application within apparatus 305 includes an imaging unit 310, an operation unit 311, a photographed video information storage unit 312, and an imaging application control unit 307.

The application 305 performs a photographed information transfer control 308 which controls a transfer of photographed storage image information and an operational information transfer control 309 which transmits user's operational information via communication with the image storage device 102. The communication control is configured in conjunction with a CPU and a memory group by which the imaging application control unit 307 is operated.

A communication control unit 304 performs control of a communication interface of the image storage device 102. The communication control unit 304 includes a CPU and a memory. A close proximity wireless communication unit 302 performs the close proximity wireless communication 103.

A connection state storage unit 317 stores which of the connection states 20 to 22 the image storage device 102 is in. An interface control unit 318 controls an interface unit 315 for outputting video information to the display 104 serving as a display apparatus.

An application within apparatus 306 provides functions of storing transferred information and displaying stored information of the image storage device 102.

For controlling the communication with the imaging device 101, an operational information control unit 320 receives user's operational information, and a video information storage control unit 319 performs control of storage and display of information. The communication control is configured in conjunction with a CPU, and a memory group by which the video information storage control unit 319 is operated.

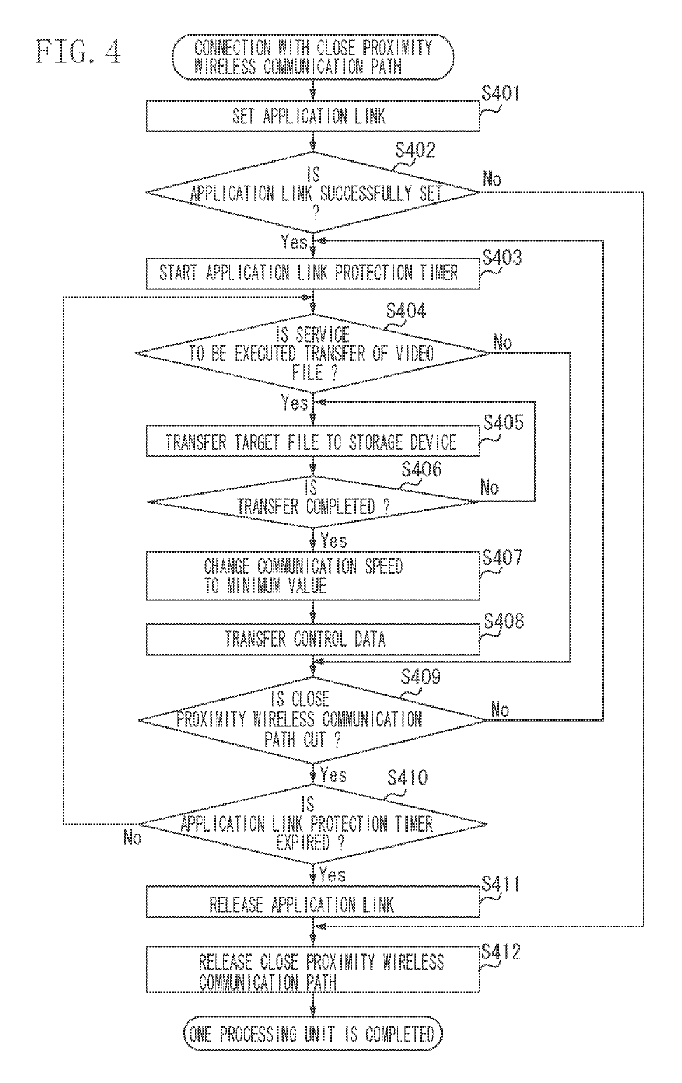

The present exemplary embodiment will be described with reference to the conceptual connection diagram in FIG. 2 and a flowchart in FIG. 4. FIG. 4 is the flowchart illustrating processing executed by the imaging device 101 for setting and releasing a link between applications, when a system according to the present exemplary embodiment is applied.

The close proximity wireless communication 103 which is connected by selecting the communication speed corresponding to the wireless connection quality becomes one of the three states 20 to 22 as illustrated in FIG. 2 depending on a distance between the communication apparatuses.

In the state 20 in which the distance between the apparatuses is well close (e.g., under 3 to 4 cm), communication at high speed is possible. However, in the state 21 in which the distance between apparatuses is far (e.g., about 10 cm), errors in the communication frames frequently occur when communication at high speed is executed.

In general wireless communication, an error in communication frames is reduced using a processing sequence of an automatic communication speed control technique for reducing a communication speed based on error detection.

In the processing, after transferring the photographed video file, a user may operate the imaging device 101. In this case, the imaging device 101 falls into a positional relationship of the state 21, and if communication is executed at high speed in the state 21, errors in the communication frames frequently occur. Therefore, the processing sequence of the automatic communication speed control technique is frequently performed, and a transmission of a message about an operation which the user has executed using the imaging device 101 to the image storage device 102 may be delayed.

In particular, if an intended reproduction operation (Fast Feed, Rewind, Still, Slow, etc.) of the transferred video file is delayed, an event responding to the instruction occurs at a reproduction part deviated from user's instruction timing, which will cause discomfort to the user.

Hence, in the present exemplary embodiment, in steps S401 to 5403, the imaging device 101 sets a link between the applications within apparatuses 305 and 306 via the close proximity wireless communication 103 path which is connected by selecting the communication speed corresponding to the wireless connection quality. In the processing, an application link protection timer is used for maintaining the link between applications for a given time, even if the close proximity wireless communication path is disconnected due to deterioration of the communication quality in the close proximity wireless communication path.

Then, in step 5404, the imaging device 101 checks if a service to be executed is a transfer of content data (first data) such as a video file.

If the service is not the transfer of the video file (NO in step S404), the processing proceeds to step 5409.

On the other hand, if the service is the transfer of the video file (YES in step S404), then in step 5405, the imaging device 101 transfers a predetermined target file to the image storage device 102. The predetermined target file refers to, for instance, a file which is selected by the user. Then, in step 5406, the imaging device 101 determines whether the transfer of the target file is completed. If the transfer is completed (YES in step S406), the processing proceeds to step S407. If not (NO in step S406), the processing returns to step S405.

After the transfer of the target file is completed, the imaging device 101 according to the present exemplary embodiment transfers control data (second data) for performing various instructions (Still, Slow, etc.) to the image storage device 102.

In step 5407, the imaging device 101 transfers subsequent data at a communication speed that does not frequently cause errors in the communication frames. More specifically, data is transferred at a reduced communication speed. Accordingly, deterioration of the communication quality can be reduced.

In the present exemplary embodiment, a minimum value is selected as the communication speed that does not frequently cause errors in the communication frames. Then, the imaging device 101 transfers to the image storage device 102 the control data (second data) for performing intended reproduction (Fast Feed, Rewind, Still, Slow, etc.) of the video file transferred to the image storage device 102.

The image storage device 102 which has received the control data performs the intended reproduction of the video file according to the received control data.

After this operation, if the close proximity wireless communication path is disconnected, the imaging device 101 appropriately releases the close proximity wireless communication path by performing the processing in steps S409 to S412.

According to the above-described processing, since the imaging device 101 transfers the control data at a low speed after having transferred the content data, an automatic communication speed control becomes unnecessary, and transmission of the message about the operation which the user has executed may not be delayed. Therefore, user's convenience is enhanced.

Further, the imaging device 101 transfers data at the low speed after transferring the predetermined data (content data), so that a distance between operable apparatuses can be increased and receiving failure probability of an operation command can be reduced.

In the present exemplary embodiment, as a method for transferring the control data with strengthened error resilience from the imaging device 101 to the image storage device 102, the data is transferred at the reduced communication speed. However, the transferring method is not limited to the above, for instance, a redundant signal for detecting and correcting an error may be added to the data. Accordingly, the above-described effect can be also obtained.

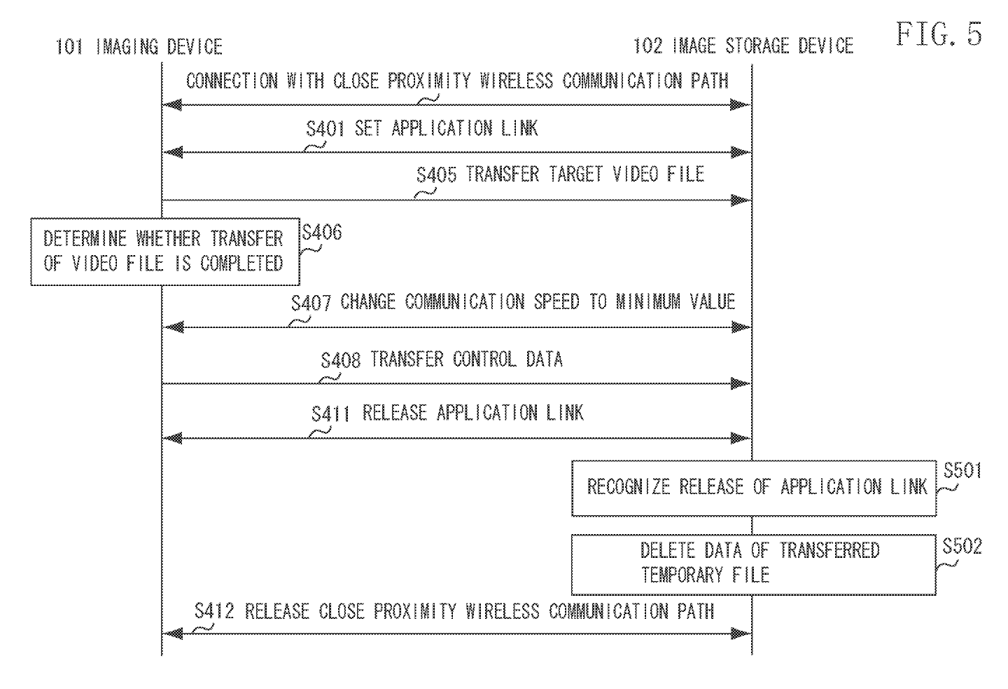

In a second exemplary embodiment, the image storage device 102 has a function of deleting a temporarily stored file after releasing an application link in step S411 in the flowchart of FIG. 4. A sequence chart in the present exemplary embodiment is illustrated in FIG. 5. The processes similar to those in FIG. 4 are designated with the same reference numerals, and descriptions thereof will be omitted. Further, since the system configuration and the hardware configuration of the present exemplary embodiment are similar to those in the first exemplary embodiment, descriptions thereof will be omitted.

If the image storage device 102 stores a video file in order to smoothly display reproduction of a moving image file or the like, it may be necessary in some cases to delete the video file after completion of reproduction display. However, in the disconnected state 22, the video file stored in the image storage device 102 cannot be deleted by an operation at the imaging device 101.

As a measure to handle the situation, when release of the application link between the applications within apparatuses 305 and 306 is recognized in step S501, the image storage device 102 add the processing for deleting temporarily stored file data which has been acquired at the image storage device 102 in step S502.

As a method for discriminating between temporarily stored file data and permanently stored file data, it is assumed to be notified during transfer processing of a transfer target video file. However, it may be designated from the operation unit 311 of the imaging device 101 after the transfer.

Further, the image storage device 102 recognizes release of the close proximity wireless communication path in step S412, and may delete the temporarily stored file data acquired at the image storage device 102 side when the release is recognized.

According to the above-described processing, even if the close proximity wireless communication 103 falls into the disconnected state 22, the image storage device 102 can appropriately discard the temporarily stored file data.

In the first and second exemplary embodiments, control data for performing intended reproduction (Fast Feed, Rewind, Still, Slow, etc.) of the video file is transferred at the reduced communication speed after the video file has been transferred to the image storage device 102.

In a third exemplary embodiment, if data which is transferred after a video file has been transferred to the image storage device 102 is control data, it will be transferred at reduced communication speed. Since the system configuration and the hardware configuration in the present exemplary embodiment are similar to those in the first exemplary embodiment, descriptions thereof will be omitted.

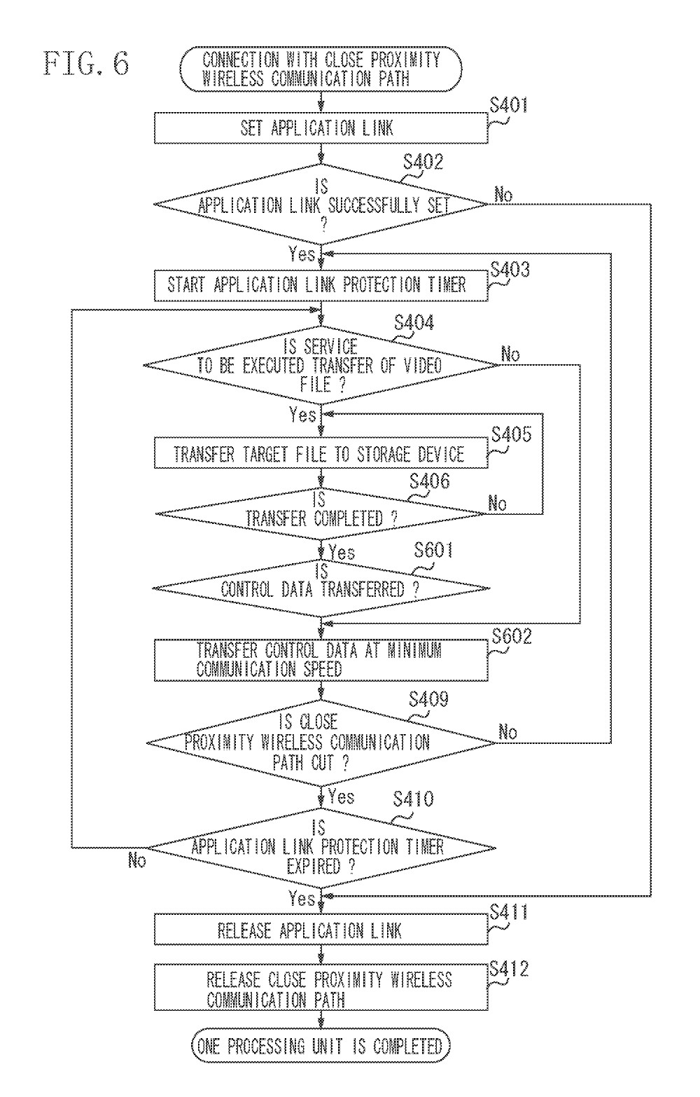

FIG. 6 is the flowchart illustrating processing executed by the imaging device 101 for setting and releasing a link between applications according to the present exemplary embodiment executes. The processes similar to those in FIG. 4 are designated with the same reference numerals, and descriptions thereof will be omitted.

Also in the present exemplary embodiment, in steps S401 to S403, the imaging device 101 sets a link between the applications within apparatuses 305 and 306 via the close proximity wireless communication 103 path which is connected by selecting a communication speed corresponding to the wireless connection quality. Then, in step in S404, the imaging device 101 checks if a service to be executed is a transfer of content data (first data) such as a video file.

If the service is a transfer of a video file (YES in step S404), then in step S405, the imaging device 101 transfers the predetermined target file to the image storage device 102. Then, in step S406, the imaging device 101 determines whether the transfer of the target file is completed. If the transfer is completed (YES in step S406), the processing proceeds to step S601. If not (NO in step S406), the processing returns to step S405.

In step S601, the imaging device 101 determines whether data to be transferred to the image storage device 102 is control data for performing the intended reproduction (Fast Feed, Rewind, Still, Slow, etc.) of the transferred video file.

If the data is the control data, then in step S602, the imaging device 101 transfers the control data by setting the communication speed low (preferably minimum speed).

According to the above-described processing, if data to be transferred subsequent to the transfer of the predetermined data (content data) is the control data, the imaging device 101 transfers the data at low speed. Consequently, the distance between operable apparatuses can be increased and receiving failure probability of an operation command can be reduced.

The exemplary embodiments of the present invention may be implemented by supplying a recording medium (storage medium) which has stored a program code of software for realizing the functions of the above described exemplary embodiments to a system or an apparatus, and by causing a computer (CPU or a microprocessor unit (MPU)) of the system or the apparatus to read and execute the program code stored in the recording medium. In this case, the program code itself read out from the storage medium realizes the functions of the above described exemplary embodiments, and the storage medium which has stored the program code will constitute the present invention.

As the storage medium for supplying program codes, for instance, a flexible disk, a hard disk, an optical disk, a magneto-optical disk, a compact disc read-only memory (CD-ROM), a CD recordable (CD-R), a magnetic tape, a nonvolatile memory card, a read-only memory (ROM), and a digital versatile disk (DVD) can be used.

Further, the functions of the above described exemplary embodiments are not only implemented by the computer that executes the read out program code, but also an operating system (OS) running on the computer which can perform a part or the whole of actual processing based on instructions of the program code.

Furthermore, the program code read out from the storage medium is written into a memory provided in a function expansion board inserted into a computer and a function expansion unit connected to a computer. Then, a CPU provided in the function expansion board and the function expansion unit may perform a part or whole of actual processing based on the instructions of the program code, to implement the functions of the above described exemplary embodiments.

Although the first and second exemplary embodiments describe examples when the present invention is applied to the close proximity wireless communication system which uses a variable communication speed, it is also applicable to a peer-to-peer communication system, such as an optical communication, which can change the communication speed.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Applications No. 2008-276986 filed Oct. 28, 2008 and No. 2008-321629 filed Dec. 17, 2008, which are hereby incorporated by reference herein in their entirety.

What is claimed is:

1. A communication apparatus comprising:
a transfer unit configured to transfer data to an external apparatus; and
a determination unit configured to determine that a transfer of first data is completed by the transfer unit,
wherein the transfer unit transfers second data, at a reduced communication speed, to cause the external apparatus to operate the first data, after the determination unit determines that the transfer of the first data has been completed.

2. A communication apparatus comprising:
a transfer unit configured to transfer data to an external apparatus; and
a determination unit configured to determine that data to be transferred is second data for causing the external apparatus to operate first data which is transmitted previously,
wherein if the determination unit determines the data to be transferred as the second data, the transfer unit transfers the second data at a reduced communication speed.

3. The communication apparatus according to claim 1, wherein the first data is content data.

4. The communication apparatus according to claim 1, wherein the transfer unit reduces a communication speed by changing a coding method

5. The communication apparatus according to claim 1, wherein the transfer unit reduces a communication speed by changing a modulation method.

6. The communication apparatus according to claim 1, wherein the transfer unit reduces a communication speed by changing a spreading code.

7. A communication apparatus comprising:
a transfer unit configured to transfer data to an external apparatus; and
a determination unit configured to determine that a transfer of first data is completed by the transfer unit,
wherein the transfer unit, after the determination unit determines that the transfer of the first data has been completed, transfers second data for causing the external apparatus to operate the first data with strengthened error resilience.

8. A communication apparatus comprising:
an acquisition unit configured to acquire data from an external apparatus;
a storage unit configured to store the data acquired by the acquisition unit; and
a deletion unit configured to delete the data stored in the storage unit, if communication with the external apparatus is disconnected.

9. A system comprising an external apparatus and a communication apparatus that can connect with the external apparatus,
wherein the communication apparatus includes:
a transfer unit configured to transfer data to external apparatuses; and
a determination unit configured to determine whether data to be transferred is second data for causing the external apparatuses to operate first data transmitted previously,
wherein if the determination unit determines the data to be transferred as the second data, the transfer unit transfers the second data at a reduced communication speed, and
wherein the external apparatuses includes:
an acquisition unit configured to acquire the first data from the communication apparatus;
a storage unit configured to store the first data acquired by the acquisition unit; and
a deletion unit configured to delete the data stored in the storage unit, if communication with the external apparatus is disconnected.
